(19) United States
(12) Patent Application Publication
(10) Pub. No.: US 2026/0088557 A1
(43) Pub. Date: Mar. 26, 2026

(54) RF MODULE HOUSING

(71) Applicant: TE Connectivity Solutions GmbH, Schaffhausen (CH)

(72) Inventors: Xiaoming LUO, Hummelstown, PA (US); Bruce Allen CHAMPION, Camp Hill, PA (US); Francis John BLASICK, Halifax, PA (US); Joshua Allen ROSENAU, York, PA (US)

(73) Assignee: TE Connectivity Solutions GmbH, Schaffhausen (CH)

(21) Appl. No.: 18/897,770

(22) Filed: Sep. 26, 2024

(51) Int. Cl. H01R 13/518; H01R 13/50; H01R 24/40

(52) U.S. Cl. CPC H01R 13/518; H01R 13/50; H01R 24/40

(57) ABSTRACT

An RF module housing with a contact receiving portion and a mounting portion. The contact receiving portion has a mating face and an oppositely facing wire receiving face. The mounting portion has two or more mounting legs. The mounting legs extend from the wire receiving face in a direction away from the mating face. The mounting legs have mounting openings which are spaced an equal first distance from the mating face of the contact receiving portion. The module housing has a mass of no more than approximately 2.0 grams for every 12 RF connections, a Von Mises stress of no more than approximately 250 MPa, and a deformation no more than approximately 0.1 mm.

### BACKGROUND OF THE INVENTION

The invention relates generally to a module housing used in high-density, high-accuracy, and high-speed data transmission applications. In particular, the invention relates to a RF module housing, such as, but not limited to a NanoRF module housing.

NanoRF module connectors may be used many industries, including the aerospace industry. The connectors are often used in high density applications. The connectors must be reliable, having good stress distribution and having minimal controlled deformation. In addition, it is desirable to minimize the weight of the connectors.

When many RF connections in an electronic system are needed, the total mass and size of NanoRF modules connectors add up quickly. In the aerospace industry, a United States Environmental Protection Agency study disclosed that one kilogram aircraft weight reduction will save 25 tons carbon dioxide emission throughout its life. Therefore, solutions to control the weight and dimensions of NanoRF modules become critical especially for aerospace applications. In addition, due to the high geometry complexity and accuracy requirements, the manufacturing of known NanoRF modules connectors is complicated.

It would, therefore, be beneficial to provide an RF modules connector which has a reduced mass while providing sufficient stress and deformation characteristics. In addition is would be beneficial to provide a RF modules, such as, but not limited to a NanoRF module housing connectors, which can be easily implemented and manufactured.

### SUMMARY OF THE INVENTION

An embodiment is directed to a RF module housing. The module housing includes a contact receiving portion with a mating face and an oppositely facing wire receiving face. The module housing also has a mounting portion with two or more mounting legs. The mounting legs extend from the wire receiving face in a direction away from the mating face. The mounting legs have mounting openings which are spaced an equal first distance from the mating face of the contact receiving portion.

An embodiment is directed a RF module housing with a contact receiving portion and a mounting portion. The contact receiving portion has a mating face and an oppositely facing wire receiving face. The mounting portion has two or more mounting legs. The mounting legs extend from the wire receiving face in a direction away from the mating face. The mounting legs have mounting openings which are spaced an equal first distance from the mating face of the contact receiving portion. The module housing has a mass of no more than approximately 2.0 grams for every 12 RF connections, a Von Mises stress of no more than approximately 250 MPa, and a deformation no more than approximately 0.1 mm.

In an embodiment, the mounting legs may have locating projections which extend from a bottom surface of the mounting legs in a direction away from a top surface of the mounting legs.

In an embodiment, the locating projections may be spaced an equal second distance from the mating face of the contact receiving portion.

In an embodiment, the locating projections may be positioned between the mating face and the mounting openings.

In an embodiment, the locating projections may be cylindrical members with openings which extend from bottom surfaces of the locating projections toward the bottom surface of the mounting legs.

In an embodiment, the locating projections may have a larger diameter than the mounting openings.

In an embodiment, the mounting legs may have reduced portions positioned between the mounting openings and the locating pins or projections.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view a NanoRF module housing according to the prior art.

FIG. 2 is a perspective view of an illustrative embodiment of an RF module housing of the present invention.

FIG. 3 is a front view of the module housing of FIG. 1.

FIG. 4 is a back view of the module housing of FIG. 1.

FIG. 5 is a side view of the module housing of FIG. 1.

FIG. 6 is a top view of the module housing of FIG. 1.

FIG. 7 is a bottom view of the module housing of FIG. 1.

### DETAILED DESCRIPTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

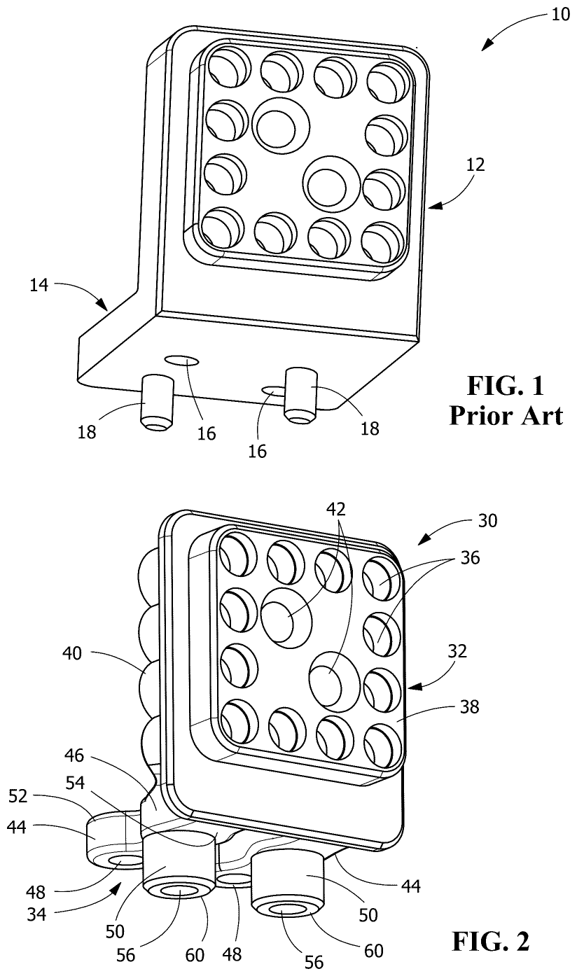

Referring to FIG. 1, a NanoRF module housing according to the prior art is shown. The module housing 10 has a contact receiving portion 12 and a mounting portion 14. The mounting portion 14 is a solid rectangular member which extends from the contact receiving portion 12. The mounting portion 14 has mounting openings 16 and locating pins 18. The location of the mounting openings 16 and the locating pins 18 are positioned at staggered distances from the contact receiving portion 12.

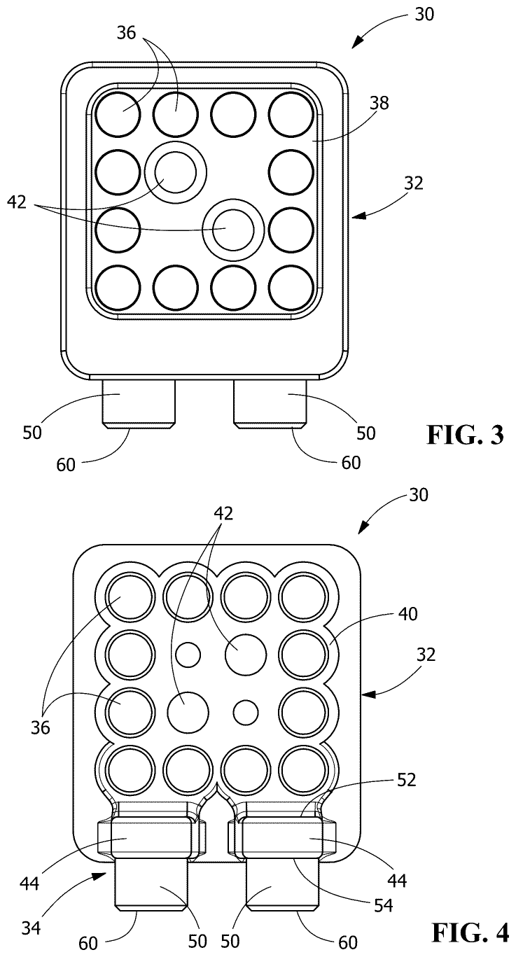

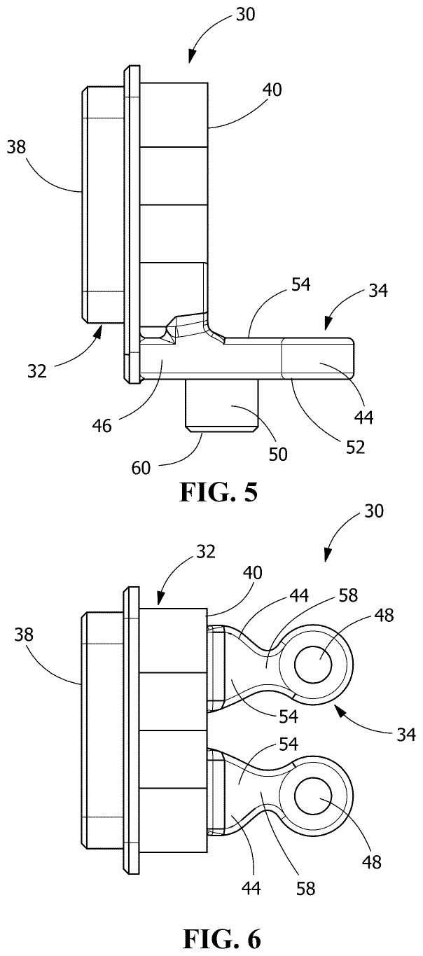

Referring to FIGS. 2 through 7, an illustrative RF module housing or coaxial contact module 30 of the present invention is shown. In the illustrative embodiment a NanoRF module housing is shown, however, the invention is not limited to NanoRF module housings. In the illustrative embodiment shown the module housing 30 has a contact receiving portion 32 and a mounting portion 34. The contact receiving portion 32 has multiple contact receiving openings 36 for receiving RF contacts (not shown) therein. The contact receiving openings 36 extend from a front or mating face 38 to a rear or wire receiving face 40 and are precisely located and manufactured to properly house the contacts. The contact receiving portion 32 also has guide pin receiving recesses 42 which extend from a front or mating face 38 to a rear or wire receiving face 40. The guide pin receiving recesses 42 are configured to accommodate guide pins (not shown) inserted therein.

In the illustrative embodiment shown, the plane of the mounting portion 34 is essentially perpendicular to the plane of the contact receiving portion 32, however other configurations may be used. The mounting portion 34 has two mounting legs 44 which extend from the wire receiving face 40 in a direction away from the mating face 38. A securing portion 46 of each of the mounting legs 44 is integrally attached or manufactured with the contact receiving portion 32.

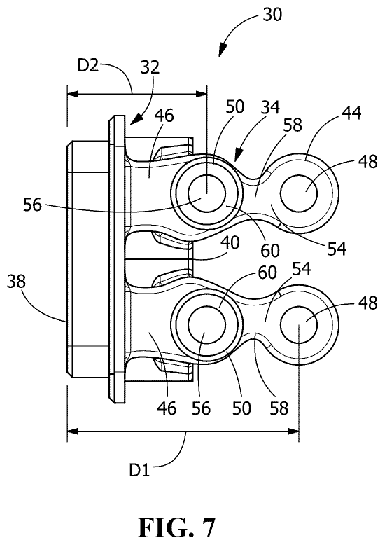

The mounting legs 44 have mounting openings 48 which extend through the mounting legs 44. The mounting openings 48 are dimensioned to receive mounting hardware (not shown) therein to facilitate the mounting of the module housing 10 to a circuit board or substrate (not shown). In the illustrative embodiment shown in FIG. 7, centers of the mounting openings 48 are spaced a distance D1 from the front or mating face 38 of the contact receiving portion 32. The positioning of the mounting openings 48 at the same distance D1 from the front or mating face 38 allows the total length of the mounting portion 34 to be reduced when compared to the mounting portion 14 of the known art. The reduced length allows for tighter spacing on the circuit board or substrate while increasing the structural integrity of the module housing 30.

The mounting legs 44 have locating pins or projections 50 which extend from bottom surface 52 of the mounting legs 44 in a direction away from the top surface 54 of the mounting legs 44. The locating pins or projections 50 are dimensioned to be positioned in locating holes (not shown) of the circuit board or substrate. In the illustrative embodiment shown in FIG. 7, centers of the locating pins or projections 50 are spaced a distance D2 from the front or mating face 30 of the contact receiving portion 32. The locating pins or projections 50 are positioned between the front or mating face 30 and the mounting openings 48. The locating pins or projections 50 are cylindrical members with openings 56 which extends from a bottom surface 60 of the locating pins or projections 50 toward the bottom surface 52 of the mounting legs 44. In the illustrative embodiment shown, the locating pins or projections 50 have a larger diameter than the mounting openings 48, thereby reducing the stress concentration on the roots or base of the locating pins or projections 50. The mounting legs 44 have reduced portions 58 positioned between the mounting openings 48 and the locating pins or projections 50.

In the illustrative embodiment shown, the module housing 30 of the present invention is optimized to maximize stiffness and reduce more than 30% materials from the module housing 10 of the known art. For example a 12 NanoRF module housing according to the present invention has a mass of no more than approximately 2.0 grams, a Von Mises stress of no more than approximately 250 MPa, and a deformation no more than approximately 0.1 mm. However, for every additional 12 NanoRF connection, an additional mass of approximately 2.0 grams is added.

In the particular embodiment of the module housing 30 shown in FIGS. 2 through 7, the mass is 1.77 gram, which is 42% mass reduction compared to the module housing 10 shown in FIG. 1. The maximum Von Mises stress of the module housing 30 was measured at 232 MPa which is essentially equivalent to the Von Mises stress of module housing 10. In addition, the largest deformation of the module housing 30 is 0.087 mm compared to the largest deformation of module housing 10 of 0.133 mm. Therefore, the module housing 30 of the present invention when compared with the module housing 10 of the known art has a 42% mass reduction and a reduced 35% deformation with the same maximum stress.

The module housing 30 may be produced by multiple different manufacturing processes, such as, but not limited to, 3D printing and CNC machining. This allows the module housing 30 to be produced quickly in order to minimize long lead-time supply issue. The also reduces the scrape material when compared to module housing which are machined from a solid block of material.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A RF module housing comprising:
a contact receiving portion having a mating face and an oppositely facing wire receiving face;
a mounting portion with two or more mounting legs, the mounting legs extending from the wire receiving face in a direction away from the mating face, the mounting legs having mounting openings which are spaced an equal first distance from the mating face of the contact receiving portion.

2. The RF module housing as recited in claim 1, wherein the contact receiving portion has multiple contact receiving openings for receiving RF contacts therein.

3. The RF module housing as recited in claim 2, wherein the contact receiving openings extend from the mating face to the wire receiving face.

4. The RF module housing as recited in claim 3, wherein the contact receiving portion has guide pin receiving recesses which extend from the mating face to the wire receiving face.

5. The RF module housing as recited in claim 1, wherein a plane of the mounting portion is essentially perpendicular to a plane of the contact receiving portion, a securing portion of each of the mounting legs is integrally attached to the receiving portion.

6. The RF module housing as recited in claim 1, wherein the mounting openings extend through the mounting legs and are configured to receive mounting hardware therein to facilitate the mounting of the module housing to a substrate.

7. The RF module housing as recited in claim 1, wherein the mounting legs have locating projections which extend from a bottom surface of the mounting legs in a direction away from a top surface of the mounting legs.

8. The RF module housing as recited in claim 7, wherein the locating projections are spaced an equal second distance from the mating face of the contact receiving portion.

9. The RF module housing as recited in claim 7, wherein the locating projections are positioned between the mating face and the mounting openings.

10. The RF module housing as recited in claim 7, wherein the locating projections are cylindrical members with openings which extend from bottom surfaces of the locating projections toward the bottom surface of the mounting legs.

11. The RF module housing as recited in claim 7, wherein the locating projections have a larger diameter than the mounting openings.

12. The RF module housing as recited in claim 7, wherein the mounting legs have reduced portions positioned between the mounting openings and the locating pins or projections.

13. The RF module housing as recited in claim 1, wherein the module housing has a mass of no more than approximately 2.0 grams for every 12 RF connections, a Von Mises stress of no more than approximately 250 MPa, and a deformation no more than approximately 0.1 mm.

14. A RF module housing comprising:
a contact receiving portion having a mating face and an oppositely facing wire receiving face;
a mounting portion with two or more mounting legs, the mounting legs extending from the wire receiving face in a direction away from the mating face, the mounting legs having mounting openings which are spaced an equal first distance from the mating face of the contact receiving portion;
the module housing having a mass of no more than approximately 2.0 grams for every 12 RF connections, a Von Mises stress of no more than approximately 250 MPa, and a deformation no more than approximately 0.1 mm.

15. The RF module housing as recited in claim 14, wherein the mounting legs have locating projections which extend from a bottom surface of the mounting legs in a direction away from a top surface of the mounting legs.

16. The RF module housing as recited in claim 15, wherein the locating projections are spaced an equal second distance from the mating face of the contact receiving portion.

17. The RF module housing as recited in claim 16, wherein the locating projections are positioned between the mating face and the mounting openings.

18. The RF module housing as recited in claim 17, wherein the locating projections are cylindrical members with openings which extend from bottom surfaces of the locating projections toward the bottom surface of the mounting legs.

19. The RF module housing as recited in claim 18, wherein the locating projections have a larger diameter than the mounting openings.

20. The RF module housing as recited in claim 15, wherein the mounting legs have reduced portions positioned between the mounting openings and the locating pins or projections.
